(19) United States
(12) Patent Application Publication
(10) Pub. No.: US 2026/0198400 A1
(43) Pub. Date: Jul. 16, 2026

(54) PROCEDURE FOR PLANNING THE PICK-UP OF CROP BALES

(71) Applicant: Maschinenfabrik Bernard Krone GmbH & Co. KG, Spelle (DE)

(72) Inventors: Alexander GREVER, Osnabrück (DE); Stefan MENKE, Südlohn (DE); Martin AMSHOVE, Ahaus (DE); Michael KREYENHAGEN, Böhmte (DE)

(21) Appl. No.: 19/361,680

(22) Filed: Oct. 17, 2025

(30) Foreign Application Priority Data
Oct. 17, 2024 (DE) 102024130219.4

(51) Int. Cl. A01B 69/04; A01D 90/08; G05D 1/644; G05D 1/667; G05D 105/15

(52) U.S. Cl. CPC A01B 69/008; A01D 90/08; G05D 1/644; G05D 1/667; G05D 2105/15

(57) ABSTRACT

The invention relates to a method for planning the collection of crop bales (30), which are arranged in a processing area (5), by a collection unit (20), comprising the steps of:
Providing (S110) arrangement information corresponding to an expected target arrangement (Sᵢ) of each of a plurality of crop bales (30), and
Computer-aided determination (S120) of an optimum route (Fₒₚₜ) for picking up the plurality of crop bales (30) on the basis of the arrangement information, in accordance with a defined optimization criterion for route optimization, the optimum route (Fₒₚₜ) containing a target approach path (W_{S1}-W_{S6}) for each crop bale (30), along which the crop bale (30) is to be approached,

In order to improve the route planning for picking up bales of harvested material, the invention provides that arrangement information is provided (S110), in which the target arrangement (Sᵢ) of at least one bale of harvested material (30) corresponds to an arrangement distribution with a plurality of arrangement possibilities, each arrangement possibility being assigned an arrangement probability, and a selection arrangement (Cᵢ) being selected from the plurality of arrangement possibilities when determining (S120) the optimum travel route (Fₒₚₜ) for at least one bale of harvested material (30).

The present invention relates to a method for planning the pick-up of crop bales, according to the general term of claim 1, and to a computer system according to claim 16.

Various types of agricultural crops, especially stalks such as grass, but also alfalfa or maize, are often processed into crop bales, for example square bales or round bales, after harvesting and, if necessary, drying. Although stationary balers are also known, in many cases the crop bales are produced by a mobile baler on the field where the crop was cut. The baler is either pulled by a tractor or is designed as a self-propelled unit with its own drive. This involves gradually driving along the parcel of land in a suitable manner, for example along the swaths that were previously laid down. When the baler has collected enough crop for a bale and has finished baling it, the crop bale can be tied with twine or netting, for example, before it is ejected. Optionally, the crop bale can also be wrapped in film. The wrapping device provided for this purpose can, for example, be attached to the baler or carried by its frame. Finally, the crop bale is placed on the field.

In a later step, the crop bales are collected and transported away. One option is to use a suitable loading vehicle, such as a tractor with an attachment, to gradually load the crop bales onto a platform wagon parked on the plot or nearby. As soon as the platform trailer is fully loaded, it can be transported by a tractor to the designated unloading point. Collecting units are also known that can both pick up and transport the crop bales. Such collection units can be individual vehicles or combinations. An example of this are so-called bale collection trailers, which have both a gripper for picking up a crop bale and a sufficient loading area or a loading area for a number of crop bales. A major advantage of such collection units is that once a crop bale has been picked up, the next crop bale can be approached immediately without first having to approach a parked platform trailer to unload the crop bale.

Due to the typically high number of crop bales on a parcel of land, which can amount to several hundred, the order and route in which the crop bales are approached one after the other is crucial for optimizing the loading process. It should be noted that the collection unit can often only pick up the crop bale in a certain relative position and possibly also only in a certain relative orientation. This means, for example, that the crop bale must lie directly in front of the collection unit in the direction of travel, with its longitudinal axis parallel to the direction of travel. The accuracy with which the relative position and orientation must be maintained naturally varies depending on the collection unit. In principle, suitable solutions for optimal route planning exist in the state of the art, which can be based on other optimization criteria in addition to time savings. In practice, however, implementation may be impaired by the fact that individual bales of harvested material are not or cannot be approached as intended.

One possible reason for this is that the position and orientation of the crop bale assumed during route planning do not correspond to reality. In many cases, position and orientation are only known with limited accuracy. Nevertheless, route planning is based on a higher level of precision. This can lead to a route being planned on the basis of position and orientation data that are incorrectly assumed to be precise, which is not feasible and is also worse than an actually feasible route.

The purpose of the invention is to improve route planning for picking up bales of harvested crops. The problem is solved by a method with the features of independent patent claim 1. Advantageous embodiments can be found in the dependent claims.

For this purpose, a method is created for planning the collection of crop bales arranged in a processing area by a collection unit. The process has the following steps:
Providing arrangement information corresponding to an expected target arrangement of each of a plurality of crop bales, and
computer-aided determination of an optimum travel route for picking up the plurality of crop bales on the basis of the arrangement information, in accordance with a defined optimization criterion for travel route optimization, the optimum travel route containing a target approach path for each crop bale, along which the crop bale is to be approached.

The crop bales may be bales of various types of agricultural crops, for example corn, alfalfa or stalks such as hay, grass or straw, and this list is not to be construed as exhaustive or otherwise limiting. There are also no restrictions on the shape of the crop bales, which can be round or square bales in particular. The crop is compressed inside the crop bale and the shape of the crop bale is secured with a suitable binding agent, for example a net, twine or thermoplastic tape. The crop bale can also be wrapped in film to prevent moisture exchange between the crop and the environment. The process involves picking up a large number of crop bales. Instead of picking up, one can also speak of collecting or gathering. It is intended that picking up is carried out by a collecting unit. This can be designed as a collecting machine or collecting vehicle with its own drive. However, it can also be a combination in which, in particular, a tractor pulls at least one vehicle without its own drive.

The crop bales are arranged in a processing area before being picked up. This normally means that each bale rests on the floor of the processing area, although the method can also be used in cases where, for example, bales are stacked on top of each other. The processing area can be, for example, a field, meadow or similar. It can be a parcel of land or part of a parcel of land. In general, this is the area in which the method according to the invention is carried out.

The procedure is used to plan the pick-up of the crop bales. This does not exclude the possibility that some embodiments of the method may go beyond planning. In the process, at least the following steps are carried out. In particular, they can be carried out in the above order. However, it cannot be ruled out that process steps are carried out at least partially simultaneously and/or in a different sequence.

In one step of the method, arrangement information is provided that corresponds to an expected target arrangement of each of a plurality of crop bales. The provisioning can include an initial determination of the arrangement information. Such a determination can be based at least in part on human observation, but a sensory determination, i.e. based on at least one sensory measurement, is preferred. However, the provision can also include enabling access to a data source in which the arrangement information is stored. Finally, the provision can include the calculation of arrangement information. In this case, for example, the calculation can be based on data read from a data source and/or sensor data based on a sensory measurement. The arrangement information refers to a plurality of crop bales, preferably to all crop bales in the processing area. For each of these crop bales, the arrangement information corresponds to a target arrangement of the same. This means that the arrangement information describes a target arrangement of each of the crop bales. As the term “target” suggests, this is an arrangement in which the crop bale should or ought to be. This means that the crop bale is expected to be in the target arrangement, especially at the time the crop bale is picked up. The target arrangement is always given in relation to a fixed reference system, in particular a global reference system, but alternatively also a local reference system such as the machining area. In general, the arrangement of the crop bale can be described by six coordinates, namely three translational and three rotational. However, the target arrangement does not have to correspond to a complete description in this respect, i.e. six coordinates do not have to be provided for each crop bale. As will be explained below, the arrangement information in the method according to the invention also provides information about a tolerance, inaccuracy or uncertainty with regard to the target arrangement. This means that the arrangement of the crop bale is only known with a limited degree of accuracy. Therefore, the target arrangement does not correspond exactly to a (e.g. six-dimensional) coordinate tuple, but to a distribution of coordinates, for example.

The arrangement information can be provided at least in part by the collection unit, but in particular it can also be provided at least in part by a computer system external to the collection unit. Such a computer system could be located in a mobile unit such as a laptop or smartphone or a vehicle. However, it could also be stationary in a building. It can be provided at least partially in the processing area or in its vicinity. However, it can also be carried out at least partially at a location that is far away from the processing area. This can refer both to access to an above-mentioned data source and to a calculation of arrangement information.

In a further step, a computer-aided determination of an optimum route for picking up the plurality of crop bales is carried out using the arrangement information, in accordance with a defined optimization criterion for route optimization, whereby the optimum route contains a target approach path for each crop bale, along which the crop bale is to be approached. A route is therefore sought along which the collection unit can approach and pick up the crop bales. This is generally possible in different ways, i.e. different routes are conceivable. In this process step, however, the route is optimized, i.e. the optimum route is sought. The route is optimal with regard to an optimization criterion, which can be defined in different ways. The determination is computer-aided, one can also say machine-aided or computer-aided. Insofar as the term “computer-aided” is used here and in the following, this includes in particular the possibility that the corresponding processes are carried out in whole or in part by software that is implemented on suitable hardware. This step and other computerized steps of the process can be carried out by a computer system, such as a Farm Management Information System (FMIS). In particular, the determination can take place automatically after the arrangement information has been provided, without a user having to trigger the determination or make other inputs.

It goes without saying that it may not be possible to examine all theoretically conceivable travel routes in this step, as this would take up too much computing power, memory and/or computing time. This means that the optimal travel route is the best route within a limited set of investigated routes. The layout information is used as the basis for determining the optimum travel route. The optimum route is designed so that the collection unit can pick up a crop bale according to its target arrangement. The optimum travel route contains a target approach path for each crop bale. The target approach route is a part of the optimum travel route that leads to the respective crop bale. Accordingly, it is designed in such a way that it enables the crop bale to be picked up based on the target arrangement. In most embodiments, the target approach paths of different crop bales therefore differ, as their target arrangements also differ. The target approach path can be defined in different ways. For example, it can be the part of the optimum route that leads to exactly one crop bale, i.e. either from the start of the travel route to the first crop bale or from one crop bale to the next. In this case, the optimum travel route would result from a sequence of target approach routes. However, it would also be possible, for example, to define a smaller or larger part of the route, in each case up to the crop bale, as the “target approach route”.

According to the invention, arrangement information is provided in which the target arrangement of at least one crop bale corresponds to an arrangement distribution with a plurality of arrangement possibilities, wherein an arrangement probability is assigned to each arrangement possibility, and wherein a selection arrangement is selected from the plurality of arrangement possibilities when determining the optimum travel route for at least one crop bale. However, as already indicated, the determination of the target arrangement is generally subject to uncertainty. This can be due to various causes, for example. If, for example, a position and/or orientation of a deposited crop bale is determined during bale placement, movements of the crop bale during or immediately after bale placement, or measurement inaccuracies, can lead to the target arrangement not being able to be determined exactly. Such uncertainties or tolerances are taken into account according to the invention in that the target arrangement of at least one crop bale corresponds to an arrangement distribution. This has a number of possible arrangements, with each possible arrangement being assigned a probability of arrangement.

This means that the target arrangement of the crop bale does not correspond exactly to a spatial arrangement (position and/or orientation), but to a distribution that comprises a number of possible positions and/or orientations. A continuous arrangement distribution could be used as a basis, whereby the arrangement probability would correspond to a probability density. Under certain circumstances, however, a discretization is useful, whereby a finite number of possible positions and orientations are taken as a basis, each of which is assigned a probability.

The use of an arrangement distribution influences the determination of the optimum route. The primary consequence is that the different arrangement options correspond to different end points for the respective target approach path. Therefore, compared to a clearly defined arrangement, there are more options for determining the target approach path. In the method according to the invention, a selection arrangement is chosen from the plurality of possible arrangements when determining the optimum route for at least one crop bale. The selection arrangement is an arrangement option that is selected from the arrangement distribution. This is based on the premise that exactly one arrangement of the crop bale must be assumed for a clearly defined route, from which a target approach path then results. The selection can be made according to various criteria, some of which are discussed below.

In any case, taking an arrangement distribution as a basis and choosing a selection arrangement from a number of possible arrangements represents a more realistic approach for planning the optimum route in many scenarios than assuming a clear, precisely determined arrangement of the respective crop bale. Planning the route is therefore more realistic. In particular, planning can take into account different options that are de facto available but are disregarded if a clearly defined arrangement is assumed.

According to one embodiment, the optimization criterion is based at least in part on minimizing a driving distance. “At least partially” in this context means that minimizing the driving distance does not have to be the only goal, but that other values should also be minimized or maximized, so that, for example, a compromise is made that may differ from minimizing the driving distance alone. In particular, it may be intended to minimize the total distance travelled on the route. Alternatively or additionally, the optimization criterion can be based at least partially on minimizing a travel time. The two criteria are not synonymous, as the collection unit can be slower when cornering than when driving straight ahead, for example. It could also be, for example, that the processing area has a gradient that allows the collection unit to travel faster in one direction than in another, for example in the opposite direction. Furthermore, alternatively or additionally, the optimization criterion can be based at least in part on minimizing an energy consumption. The estimated energy consumption for the entire route is normally considered here. This depends on the total distance traveled, but may also depend on other parameters. The energy consumption can also depend on whether the collection unit has to cope with a more or less steep incline, for example.

Under certain circumstances, the optimization criterion can consist of minimizing or maximizing a single variable or a single optimization value, for example minimizing the entire route. Depending on the nature of the processing area, the performance data of the collection unit and/or other factors, the minimization or maximization of one optimization value may compete to a certain extent with an equally desirable minimization or maximization of another optimization value. In this case, the isolated optimization of a single optimization value is often not a satisfactory solution. One design therefore provides for the optimization criterion to be based on the optimization of a weighted combination of optimization values. Instead of a weighted combination, one can normally also speak of a linear combination, although in principle it would be conceivable for an optimization value to enter non-linearly, but for example quadratically. One optimization value could be, for example, the distance travelled, while another optimization value is the travel time. The optimization criterion could then lie in the minimization of a sum, whereby one summand is proportional to the travel time and another summand is proportional to the travel distance. The relative weight of the respective optimization value can be adjusted by selecting suitable weighting factors or normalization factors. The sum can also be regarded as the “total optimization value” Wₜₒₜₐₗ, which is defined as follows:

$${W}_{total} = {\sum }_{k} {a}_{k} {W}_{k}$$

where Wₖ is the k^{th} optimization value, for example the distance, travel time, etc., and aₖ is the respective weighting factor. Alternatively, the optimization criterion can be based on a Pareto optimization of several optimization values. This means that a route is sought which optimizes the optimization values to the extent that no other route improves one of the optimization values without worsening another.

One embodiment provides for the selection arrangement to be selected as a function of both its arrangement probability and the optimization criterion. The selection of the selection arrangement is therefore partly based on the arrangement probability assigned to it, but not exclusively. This means that the most probable arrangement option is not necessarily selected, but the optimization criterion is also taken into account. It is therefore also taken into account how the selection of an arrangement option affects the optimum route. In general, the optimal route will have different advantages with regard to the optimization criterion, depending on which arrangement option is selected. For example, a first arrangement option could mean that the collection unit has to make a comparatively tight turn in order to approach the crop bale, which can have a negative effect on the length of the route and/or the travel time. A second arrangement option could allow the collection unit to make a less tight turn, i.e. to approach the crop bale more directly. In this respect, the second arrangement option would be more advantageous. However, the arrangement probabilities must also be taken into account. However, if the arrangement probability assigned to the first arrangement option is greater than that of the second arrangement option, it may still be possible to select the first arrangement option. Whether this is the case depends in particular on the way in which the arrangement probability is taken into account. This can be handled differently depending on the design. Qualitatively, for example, the influence on the optimization value(s) can be weighted with the arrangement probability. However, a variety of configurations are conceivable. For example, arrangement options below a certain arrangement probability could always be rejected.

In most embodiments of the method, the target arrangement corresponds to at least one translational position of a crop bale. In particular, the target arrangement of a crop bale can correspond to at least one translational position and at least one rotational orientation of the same. The translational position indicates where the crop bale should be located. It can advantageously correspond to two or three coordinates, for example length, width and optionally height. Different coordinate systems can be used, for example geographical coordinates or GNSS coordinates. The rotational orientation specifies the position and orientation in which the crop bale should be arranged. It can advantageously correspond to one, two or three coordinates, each of which expresses angles. In the case of round bales, one or two coordinates are sufficient, as rotation around the symmetry axis of the crop bale is irrelevant. In the case of a rectangular bale, three coordinates may be necessary, but depending on the shape of the crop bale and the type of collection unit, one or two coordinates may be sufficient. Since the target arrangement according to the invention corresponds to an arrangement distribution, it does not in any case correspond exactly to a translational position and a rotational orientation of the crop bale. Rather, a plurality of translatory positions and/or a plurality of rotatory orientations are provided. Each combination of position and orientation corresponds to a possible arrangement.

Preferably, in a further step of the method, the crop bales are approached by the collection unit, whereby a real arrangement of the respective crop bale is determined as it approaches and the crop bale is approached along a real approach path in accordance with the real arrangement. This means that the actual collection of the crop bales is planned in this step, for which the collection unit approaches the crop bales. In particular, the approach can be carried out at least partially in accordance with the optimum route. The collection unit can therefore at least partially orient itself to the optimum route. When the collection unit approaches a crop bale, an actual arrangement of the crop bale is determined, which is referred to here and in the following as the real arrangement. The “approach” to the crop bale can take place in particular when it is approached, i.e. when this crop bale is to be picked up next. More generally, however, this can be any approximation that makes it possible to determine the real arrangement. The real arrangement can match the target arrangement or deviate from it. The crop bale is approached along a real approach path according to the real arrangement. The real approach path must always be based on the real arrangement, as this is the only way to successfully pick up the crop bale. Although the approach paths are referred to by different terms, the real approach path can match the target approach path.

Within the scope of the invention, it is possible for a driver of the collection unit to recognize the real arrangement of a crop bale visually, i.e. with the eyes, and accordingly steer the collection unit manually along the real approach path. However, the real arrangement is preferably determined by sensors. This means that it is determined by means of at least one sensor unit. Preferably, the collection unit has the sensor unit. It can be permanently integrated into the collection unit or arranged on the collection unit for use as required. Different passive and/or active sensor units can be used. In particular, cameras that can receive visible light and/or infrared light can be used as passive sensors. Ultrasonic, radar or lidar sensors, for example, can be used as active sensors. The sensor data can preferably be analyzed automatically in order to obtain numerical values for the real arrangement. In one embodiment, the real arrangement and preferably the real approach path are determined automatically. This means that the real arrangement is determined without a user having to participate or trigger this. A control unit, which can in particular be part of the collection unit, can scan the surroundings of the collection unit by means of a sensor unit mentioned above and, for example, determine the real arrangement of a crop bale as it approaches. The real approach distance can be determined according to the real arrangement. Although a user, for example a driver, could determine the real approach path by eye, it is preferable that this also happens automatically, i.e. without user intervention. The control unit can determine a suitable real approach path from the real arrangement of the crop bale and the current arrangement of the collection unit. Alternatively, the above-mentioned computer system could also determine the real approach path after it has received the real arrangement and the current arrangement from the collection unit. In this embodiment, however, it is possible for a driver to control the collection unit manually along the automatically determined real approach path.

In a preferred embodiment of the method, if the real approach path of a crop bale deviates from the target approach path, the optimum route is at least partially determined again, taking into account the deviating real approach path. This means that if the real approach route deviates from the target approach route, the optimum travel route is recalculated in full or in part. The reasons for a deviation from the target approach path can be different, for example an obstacle can block the target approach path, which is why a deviating real approach path is used. In the case of manual control of the collection unit, a driving error could also occur, for example because the driver is temporarily distracted. In particular, however, a deviation of the real arrangement from the selection arrangement can lead to the target approach path not being maintained. The route is at least partially redetermined, i.e. at least part of the route is replanned. Preferably, the route is redetermined for at least one crop bale still to be picked up, more preferably for a plurality of crop bales still to be picked up, particularly preferably for all crop bales still to be picked up.

Re-determining or re-planning the optimum route does not necessarily have to lead to a change in the entire remaining route. The newly determined optimal travel route can match the previously determined route, at least in parts. It would also be conceivable for the new determination to be limited to a certain number of subsequent bales of harvested crop. However, such an approach can be disadvantageous, as a new determination of the route can also result in a different sequence of the crop bales. It is therefore generally not possible to determine a priori which crop bales are next on the route. The deviation of the real approach path from the target approach path can change the position and/or orientation of the collection unit after the bale has been picked up. This in turn can mean that a return to the originally planned optimal route would be inconvenient. Instead, a different route may now be optimal, which is why it makes sense to determine it again. It is also possible, for example, that a different crop bale is easier to reach than the one originally intended next due to a change in the arrangement of the collection unit. The optimum travel route is recalculated “taking into account the deviating real approach path”, which is not to be interpreted as meaning that the entire real approach path must be taken into account. Only part of the real approach path can also be taken into account, in particular the position and orientation of the collection unit at the end of the real approach path. In order to avoid possibly unnecessary redeterminations of the route, it is possible that the route is only redetermined at least partially if the deviation is classified as significant. This means that a criterion can be defined with regard to the deviation of the real approach route from the target approach route as to when a deviation is to be regarded as significant. If this criterion is not met, the deviation is considered insignificant and is disregarded.

The redetermination of the optimum route described above depends on a deviation of the real approach route. This means that it assumes that the real approach route is already known, at least in part. In addition to this, it can be provided that if the real arrangement of a crop bale deviates from its selection arrangement, the optimum travel route is at least partially determined again, taking into account the deviating real arrangement. In this case, the real approach path of the corresponding crop bale does not yet have to be known. No deviation of the real approach distance from the target approach distance must be recognizable. However, if a deviation of the real arrangement from the selected arrangement is already recognizable, this can be taken into account when replanning the optimal route. The deviating real arrangement can lead to a deviating real approach path in the further course anyway, so that this criterion for redetermination would also apply. However, it is possible to carry out the redetermination earlier on the basis of the deviating real arrangement. In particular, it is also possible to consider more than just the next crop bale. It would be conceivable that the collection unit approaches a bale of harvested crop, but it is already determined by sensory means, for example, that there is a deviation from the real arrangement in the following bale of harvested crop. When recalculating the route, in this case, in addition to a possible deviation with regard to the crop bale currently to be approached, a deviation with regard to the following bale can also be taken into account. The crop bale taken into account does not have to be the next bale on the (previously planned) route. By default, the collection unit could determine the real arrangement of each crop bale that enters its sensory detection area. Even if one or more other crop bales still have to be approached in advance with regard to the planned sequence, the real arrangement of the corresponding crop bale can already be taken into account. This allows greater planning security to be achieved at an early stage. It is also possible that the number of necessary reinvestigations can be reduced. As described above with regard to the deviating real approach route, it is only possible for the route to be at least partially redetermined if the deviation is classified as significant. This means that with regard to the deviation of the real arrangement from the selection arrangement, a criterion can be defined as to when a deviation is to be regarded as significant. If this criterion is not met, the deviation is considered insignificant and is disregarded.

As already mentioned, the collection unit can be controlled manually, with a driver guiding the collection unit to the individual crop bales. According to another preferred embodiment, the collection unit moves autonomously to the crop bales and picks them up autonomously. This means that the collection unit can collect the crop bales without being controlled by a user. In this embodiment, the real arrangement and the real approach path must be determined automatically, as otherwise it is not possible to approach the crop bales autonomously. However, the determination of the real arrangement and real approach path on the one hand and the autonomous control of the collection unit on the other could be carried out by different units. However, it can be considered advantageous if these processes are carried out by the same unit.

Preferably, the arrangement information is determined at least partially based on operating data from a baling unit that has deposited the crop bales in the processing area. The baling press unit has a baling press that can be self-propelled. Alternatively, the baler can also be pulled by a tractor, which can also be regarded as part of the baling unit. A wrapping unit can also be attached to the baler, which wraps the pressed crop bale with a film before it is deposited. In this case, the wrapping unit is also part of the baling unit. The baling unit has pressed and deposited the crop bales in a processing step preceding the bale's pick-up. Operating data of the baling press unit can be all data related to the operation of the baling press unit. In particular, this can be position data that correspond to a position of the baling press unit and/or orientation data that correspond to an orientation of the baling press unit. If the baling press unit is designed as a team, data on the relative arrangement of the individual parts of the team can also be included. The operating data can also correspond to the time or location of a bale deposit. If, for example, it is known when a crop bale was deposited, conclusions can be drawn about the arrangement of the crop bale if the position and orientation of the baling unit are known at this time. If the operating data is directly related to the bale placement, it can possibly be used directly as arrangement information. However, it can also be taken into account that measurement errors or a bale movement not recorded in the operating data can lead to a deviation from the target arrangement. The underlying movement of the crop bale (rolling, bouncing off the ground, etc.) can only be described statistically under certain circumstances. The same applies to a measurement error. Therefore, the arrangement distribution in particular can be determined at least partially based on operating data.

Additionally or alternatively, the arrangement information can be determined at least partially based on area data describing the nature of the processing area. Such area data includes, for example, data that describes an altitude profile. If there is a slope in a section of the processing area, the crop bales may tend to move in the direction of the slope during bale placement. Qualitatively, the target arrangement, i.e. the arrangement distribution, can shift accordingly. Apart from the height profile, the ground conditions can also be taken into account. This can influence how much or how far the crop bale moves.

For example, it can roll differently well on different surfaces. For example, crop residues such as stubble can slow down the crop bale. The crop bale can also bounce off the ground to varying degrees. A soft floor can absorb more energy on impact than a hard floor. These effects can also be taken into account when determining the arrangement distribution.

Preferably, the operating data describes at least one baler travel route of the baling unit. The baler travel route is the route along which the baling unit has traveled within the processing area while depositing the crop bales. The travel route of the press does not have to be fully documented in the operating data; for example, it can also involve waypoints that may be further apart. The baler travel route can be used to determine at least approximately in which area crop bales can be arranged. In particular, the crop bales can be arranged along the baler route. However, this is not necessarily the case. Depending on the nature of the crop bales, the type of placement process, the nature of the subsoil, etc., there may also be a significant deviation.

Advantageously, the operating data can describe the positions and/or orientations of crop bales. This operating data can be generated directly by the baling press unit. This means that the baling press unit can determine the position and/or orientation of the crop bale directly when the bale is deposited and make it available as part of the operating data. This operating data can be used directly as arrangement information. However, it would also be conceivable to consider that the baling unit places the crop bale in a certain position and orientation, but that the crop bale could still move without being detected by the baling unit. For example, the crop bale could continue to roll and/or bounce off the ground before finally coming to rest. Such processes can be taken into account when determining the arrangement information, which means that a target arrangement of a crop bale does not necessarily reflect the position or orientation contained in the operating data.

Even if the exact time or location of each bale deposit is not known, conclusions can be drawn from the baler route. One embodiment provides for the positions of crop bales to be estimated on the basis of the baler route and a deposit interval in order to determine the arrangement information. The deposit interval is the distance the baler press unit travels between two bale deposits. If the position of a crop bale and the baler travel route are known, the positions of all crop bales could in principle be determined if the placement interval is known. This is based on the idea that the baler unit deposits a crop bale, then travels a distance corresponding to the deposit interval along the baler travel route, and then deposits the next crop bale. Once a crop bale has been located along the baler route, the target arrangements of other crop bales can be determined as described.

For the process variant described above, it is advantageous to determine the storage interval as precisely as possible. This is generally not constant, but can depend on various parameters. In particular, it may be provided that the deposit interval is determined on the basis of parameters relating to the baling unit, a crop processed by the baling unit and/or weather conditions. It goes without saying that the baling press unit itself, i.e. its design and mode of operation, influence the deposit interval. If the baling unit is set up to produce larger crop bales, this results in a longer deposit interval than with smaller crop bales. The type and nature of the crop from which the crop bales are produced also influences the placement interval. There is a different depositing interval for straw, grass or hay. The placement interval also depends on the crop density, which can also vary for a particular crop (e.g. grass) depending on the soil and growing conditions. However, the population density can be determined at least approximately. Weather conditions can also influence the placement interval, especially precipitation and humidity, which in turn influence the moisture content of the harvested crop. If the baled crop contains a lot of moisture, it has a larger volume, and a crop bale of a certain size results after a shorter placement interval.

It is also possible to estimate the orientation of crop bales based on the baler route to determine the arrangement information. If the design and the depositing process of the baler unit are known, this results in a relationship between the orientation of the baler unit and that of a deposited crop bale. The orientation of the baler unit can in turn be determined from the baler route. The local orientation of the baler travel route can approximately correspond to the orientation of the baler unit, although deviations may occur depending on the structure of the baler unit, for example depending on the number of vehicles in the baler unit, the number and arrangement of the steerable axles, etc. Some embodiments may also take into account that the orientation of the bale deposit may differ from the orientation of the lying crop bale due to rolling and/or bouncing of the crop bale.

If information is available about when or where the baling unit has deposited a crop bale, it makes sense to determine the target arrangement in relation to this. Either information about the arrangement of the baling unit can be used or—if this is provided by the baling unit, for example—information about the arrangement of the crop bale when it is deposited. One embodiment provides that the determination of the desired arrangement of a plurality of crop bales is based on a depositing arrangement which corresponds to a position and/or orientation of the baling unit or of the respective crop bale when the crop bale is deposited, and this is combined with a relative arrangement of the crop bale [1} relative {2] to the depositing arrangement. This means that a storage arrangement is used, which is combined with a relative arrangement. The relative arrangement is an arrangement relative to the storage arrangement, i.e. in a reference system defined by the storage arrangement. The deposit arrangement can correspond to a position and/or orientation of the baling press unit. This can relate to different parts of the baling press unit. In the case of a trailer, the orientation of the baler can be used, as well as the position of any part of the baler, for example a part from which the crop bale is deposited or dropped. The relative arrangement could, for example, define a position range that is arranged a certain distance behind the position of the baling press unit, whereby the directions “front” and “rear” can be defined using the deposit arrangement. Each depositing process along the baler travel route results in a different depositing arrangement, as the position and possibly orientation of the baler unit change. This results in different target arrangements for a number of crop bales, even if the same relative arrangement is always used as a basis. However, it is also possible to change the relative arrangement. The change can be made depending on parameters that describe the processing area, for example. In particular, a local gradient could be taken into account. Depending on such a gradient, the relative arrangement could be modified.

The target arrangement, i.e. the arrangement distribution of the respective crop bales, can be defined once and then no longer changed. However, it is also conceivable that the target arrangement can be adjusted for those crop bales that have not yet been approached. In particular, experience with bales of harvested material that have already been approached and picked up can be used. One embodiment provides for the target arrangement of at least one crop bale still to be approached to be updated based on the actual arrangement of at least one crop bale that has already been approached. This can be based in particular on a comparison of the real arrangement with the arrangement distribution of the crop bale that has already been approached. If the real arrangement corresponds to an arrangement possibility to which only a very low arrangement probability was assigned, this may indicate an incorrect arrangement distribution. Such an assumption is particularly reasonable if the real arrangements of several crop bales show similar deviations. For example, the crop bales could generally be further away from the placement position than would be expected based on the arrangement distribution. Based on this experience, the arrangement distribution (especially the arrangement options with increased arrangement probability) could be shifted further away from the storage position. This purely qualitative form of customization can be implemented in different ways. Other forms of adaptation are also conceivable, for example an expansion or narrowing of the arrangement distribution, which allows a greater or lesser spread of the positions and/or orientations of the crop bales to be taken into account. In addition to these examples, other forms of adaptation are also conceivable. The target arrangement of a crop bale still to be approached can be updated in particular by updating the relative arrangement. This is because certain errors in the relative arrangement have the same qualitative effect on all crop bales. It can therefore be assumed that a correction that leads to a better match with the real position for crop bales that have already been approached will have a comparable effect for crop bales that are still to be approached.

The invention also provides a computer system. This is used to plan the collection of crop bales arranged in a processing area by a collection unit, whereby the computer system is set up:
to record arrangement information corresponding to an expected target arrangement of each of a plurality of crop bales, and
to computer-aided determination of an optimum route for picking up the plurality of crop bales on the basis of the arrangement information, in accordance with a defined optimization criterion for the travel route optimization, the optimum route containing a target approach path for each crop bale, along which the crop bale is to be approached.

According to the invention, the computer system is set up to record arrangement information in which the desired arrangement of at least one crop bale corresponds to an arrangement distribution with a plurality of arrangement possibilities, wherein an arrangement probability is assigned to each arrangement possibility, and wherein a selection arrangement is selected from the plurality of arrangement possibilities when determining the optimum route for at least one crop bale.

The computer system has at least one computer or a computer or a data processing unit. It can also have other components, for example wireless and/or wired interfaces for one-way or two-way communication with other devices. In particular, the computer system can be a farm management information system that is located outside the collection unit, for example stationary inside a building. The computer system could also be arranged in a mobile unit, for example a laptop, tablet, smartphone, etc., which displays control instructions for a driver of the collection unit or transmits control data, in particular wirelessly, to the collection unit. More generally, the computer system can be external to the collection unit and can be set up to generate the control data for transmission to the collection unit. It can have an interface for data transmission to the collection unit and can be set up to transmit the control data to the collection unit, in particular by wire and/or wirelessly. Alternatively, the computer system can be integrated into the collection unit, i.e. it can be part of the collection unit and arranged within it. In any case, the computer system can be partially realized by software.

The other terms have already been explained with reference to the method according to the invention and are therefore not explained again. Preferred embodiments of the computer system according to the invention correspond to those of the method according to the invention.

The invention is described below with reference to drawings. The drawings are merely examples and do not limit the general scope of the invention.

Shown by:

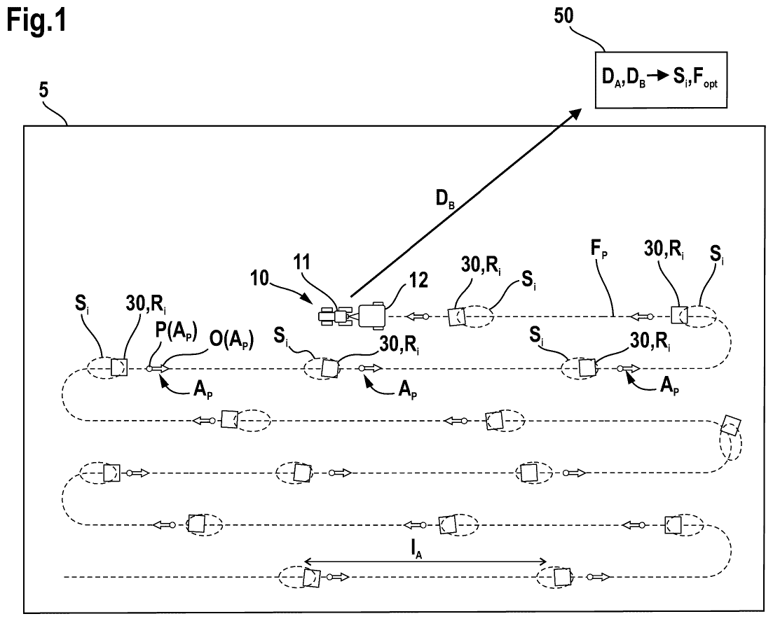

FIG. 1 a schematic top view of a processing area with a baling press unit and a computer system according to the invention;

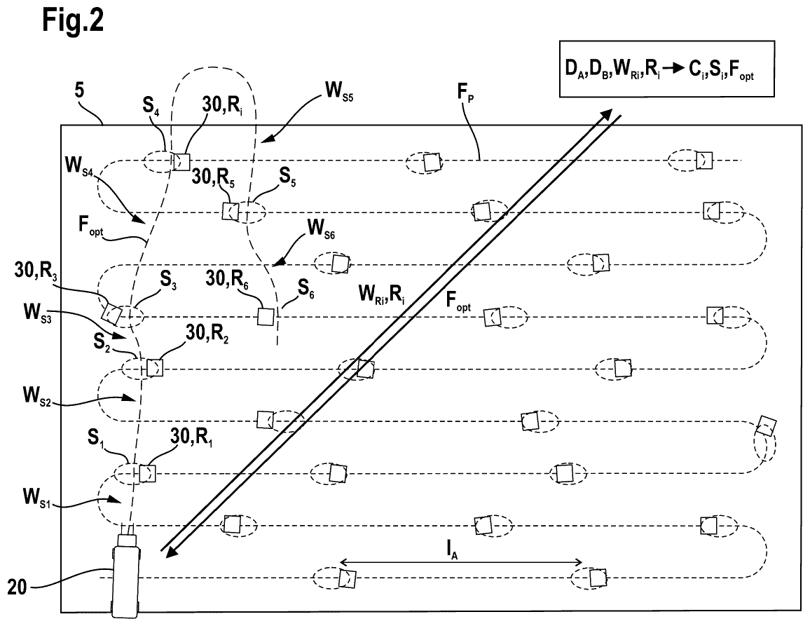

FIG. 2 a schematic top view of the processing area with a collection unit and the computer system;

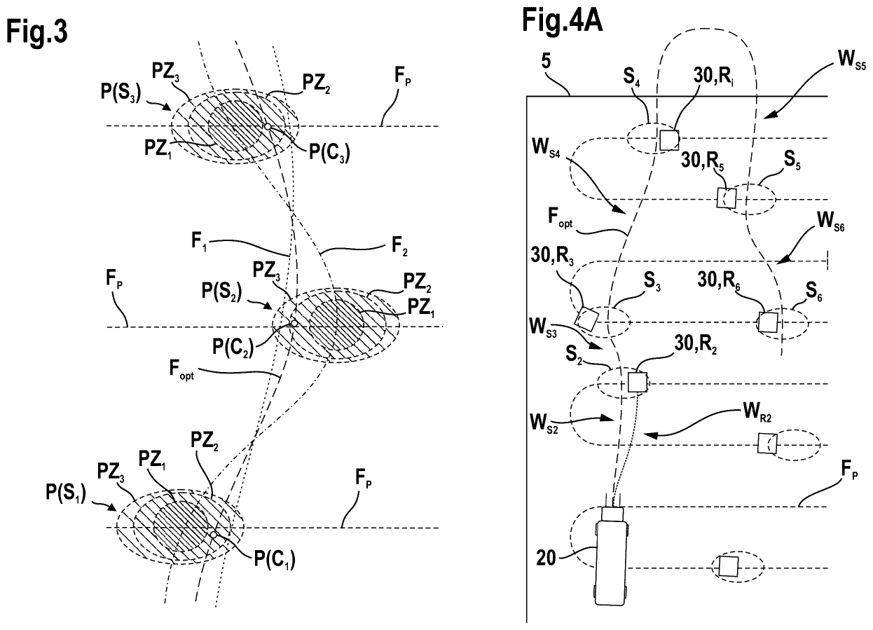

FIG. 3 a top view of a part of the processing area with target arrangements of crop bales, an optimal travel route and non-optimal routes.

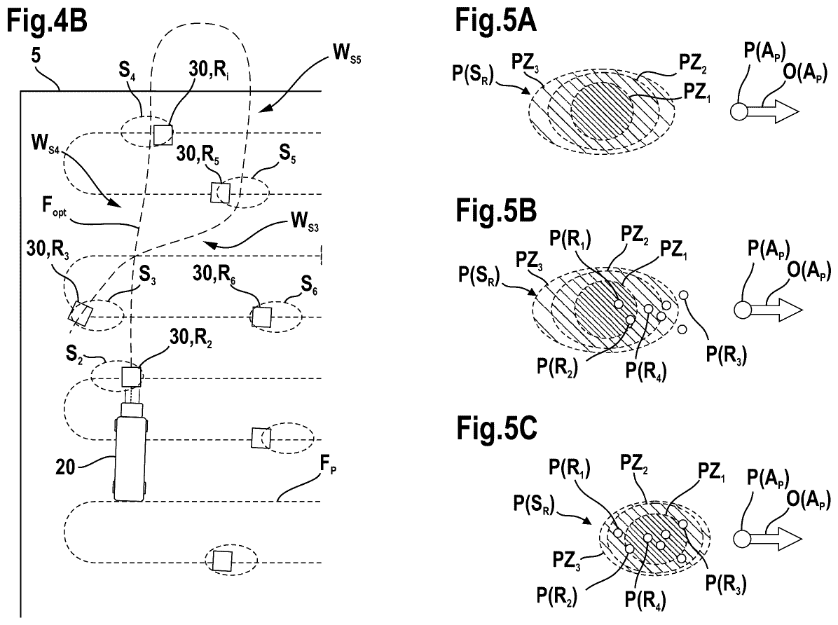

FIG. 4A, 4B top views of a part of the processing area with an optimal travel route before and after a new determination;

FIG. 5A-5C schematic representations of a storage arrangement and a relative arrangement;

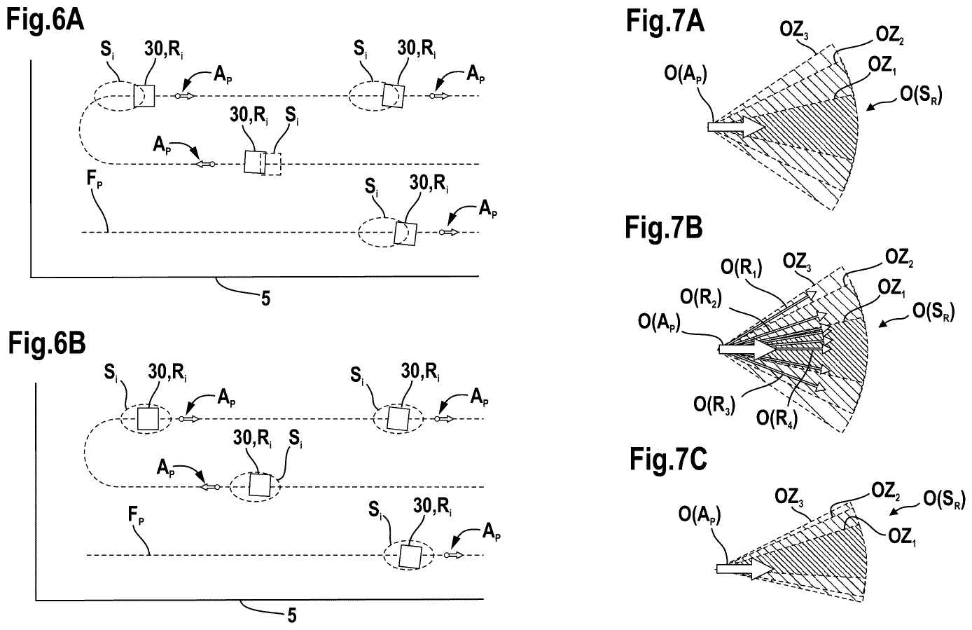

FIG. 6A, 6B top views of a part of the processing area with target arrangements of crop bales before and after a new determination;

FIGS. 7A-7C schematic representations with one deposit arrangement and one relative arrangement;

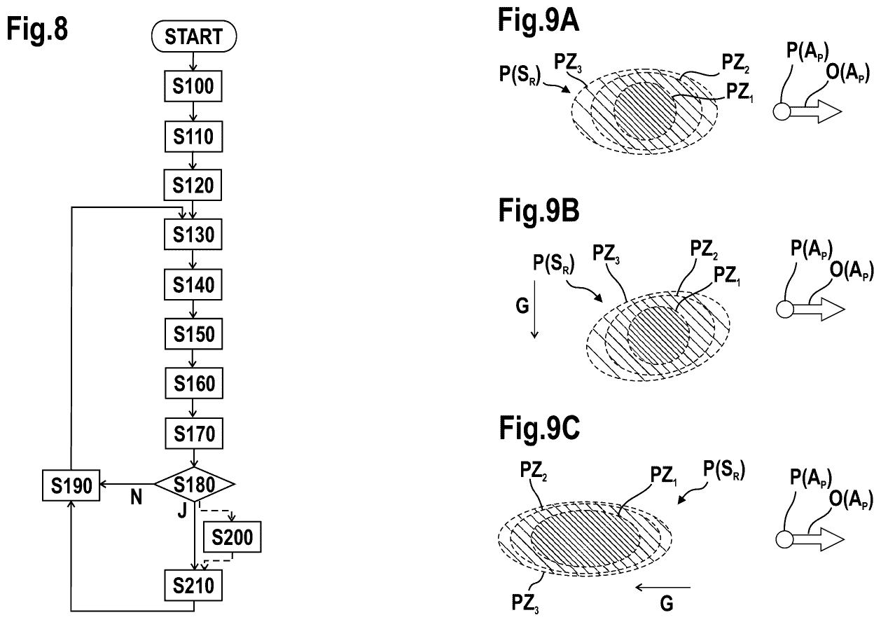

FIG. 8 a flow chart of a method according to the invention;

FIG. 9A-9C schematic representations, each with a storage arrangement and a relative arrangement.

FIG. 1 shows a processing area 5 with a baling press unit 10, which travels along a press travel route F_{P}. The baling unit 10, which in this case is formed by a tractor 11 and a baling press 12 attached to it, picks up the crop lying on the floor of the processing area (not shown) and presses it into crop bales 30, for example round bales or square bales. In this way, a plurality of crop bales 30 are gradually deposited in the processing area 5, whereby a real arrangement Rᵢ of the crop bales 30 is approximately oriented to the baler travel route F_{P}. Here and in the following, “i” is an index for a number that can be assigned to the respective crop bale 30. Between two successively deposited crop bales 30 there is a depositing interval I_{A}, the length of which can vary depending on a number of factors. First of all, the deposit interval I_{A} depends on the design and type of the baler 12 and, if necessary, on parameters that can be set on the baler 12, such as a bale diameter. Furthermore, the type and nature of the crop from which the crop bales 30 are produced influence the placement interval I_{A}. The nature of the crop also includes a crop density, which can vary depending on the nature of the soil and growing conditions. Finally, weather conditions can influence the storage interval I_{A}, especially precipitation and humidity. These change the moisture content of the crop and thus its compressibility.

FIG. 8 shows a flow diagram of one embodiment of a method according to the invention. In a first step S100, the baling press unit 10 sends operating data D_{B} to a computer system 50 according to the invention. This can be stationary in a building, for example. Even if the computer system 50 is shown next to the processing area 5 in the schematic diagram in FIG. 1, it may be far away from it in reality. For example, it can be located on a farm to which processing area 5 is assigned. The baler unit 10 communicates with the computer system 50 wirelessly, for example via a mobile phone network. The_{DB} operating data can have different contents. In particular, they can describe the baler route F_{P}, for example in the form of GNSS coordinates determined by the baling press unit 10. As indicated in FIG. 1, a placement arrangement A_{P} can be determined and transmitted for each crop bale 30. In this case, the deposit arrangement A_{P} contains a translational position P and a rotational orientation O of the baler 12 during bale deposit, i.e. at the time when a finished crop bale 30 leaves the baler 12. The orientation O shown as an empty arrow in the figures corresponds to the current direction of travel of the baler 12, i.e. runs (anti-)parallel to its longitudinal axis.

In a further step S110, the computer system 50 determines a target arrangement Sᵢ for each crop bale 30 from the operating data D_{B}, in particular from the deposit arrangements A_{P}. The computer system 50 may also include area data D_{A} describing a condition of the processing area 5. Such area data D_{A} can, for example, describe the ground conditions or a locally present gradient G. The area data D_{A} can generally influence the movement of a crop bale 30 after leaving the baler 12. The target arrangement Sᵢ contains a translational position P and a rotational orientation O of the respective crop bale 30. It corresponds to an expected arrangement, which is to be distinguished at least conceptually from a real arrangement Rᵢ of the crop bale 30, which is its actual arrangement. The target arrangements Sᵢ form arrangement information that forms the basis for further process steps. However, the respective target arrangement Sᵢ corresponds to an arrangement distribution with a number of arrangement options. The arrangement distribution is shown as an elliptical outline in FIGS. 1 and 2. Strictly speaking, this only shows the position portion of the arrangement distribution, whereby an equally relevant orientation portion is not shown for display reasons. To determine the target arrangement Sᵢ, the computer system 50 can start from the deposit arrangement A_{P} and combine this with a relative arrangement S_{R}, which describes the arrangement of the crop bale 30 in the reference system of the deposit arrangement A_{P}. FIG. 5A shows an example of a relative arrangement S_{R}, where the dashed line corresponds to the boundary of a range with non-negligible arrangement probability. The recognizable offset relative to the deposit arrangement A_{P} can be based on a design-related position difference between the point at which the crop bale 30 leaves the baler 12 and the point at which a position sensor is arranged, which determines the deposit arrangement A_{P}. In addition, it can also be taken into account that the crop bale 30 continues to move after leaving the baler 12, for example rolling or bouncing.

FIG. 5A shows the arrangement distribution in relation to the storage arrangement A_{P}. To simplify matters, three position zones PZ₁, PZ₂ and PZ₃ are shown, within which the arrangement options lie. The arrangement probability is high in a first position zone PZ₁, lower in a second position zone PZ₂ and lowest in a third position zone PZ₃. Of course, a continuously varying arrangement probability can also be assumed instead of a zone-by-zone constant arrangement probability. FIG. 7A shows three orientation zones OZ₁, OZ₂ and OZ₃, within which the orientations of the arrangement options lie. The arrangement probability is high in a first orientation zone OZ₁, lower in a second orientation zone OZ₂ and lowest in a third orientation zone OZ₃. Alternatively, a continuously varying arrangement probability could also be assumed here.

Another possibility for determining the target arrangements Sᵢ could be that the baling unit 10 detects the position P and the orientation O of the deposited crop bale 30 and transmits these directly to the computer system 50 together with the operating data D_{B}. Another possibility would be to estimate the placement interval I_{A} and then determine the arrangement of the crop bales 30 along the baler route F_{P} starting from the starting point of the baler travel route F_{P}. The respective orientation of a crop bale 30 can be estimated on the basis of the direction of travel of the baler unit 20 resulting from the course of the baler travel route F_{P}. Regardless of how the arrangement information is provided, it is possible that the target arrangement Sᵢ of a crop bale 30 is offset from its real arrangement Rᵢ. In FIG. 1, this applies to all crop bales 30.

In a step S120, the computer system 50 determines an optimal route Fₒₚₜ for a collection unit 20 to pick up the crop bales 30 based on the arrangement information. This is based on an optimization criterion that is aimed at optimizing one or more optimization values, i.e. minimization or maximization. Possible optimization values are, for example, a driving distance, a driving time or an energy consumption. A weighted combination of these optimization values can also be used as a basis. FIG. 2 shows part of the route Fₒₚₜ determined in this way, which runs along the target arrangements S₁-S₆ of six exemplary crop bales 30 shown. In each case, a section of the optimum travel route Fₒₚₜ forms a target approach route W_{S1}-W_{S6} to one of the crop bales 30.

Since the target arrangement Sᵢ is given as an arrangement distribution, the optimum route Fₒₚₜ is planned in a different way than with a clearly given target arrangement Sᵢ. In this case, the optimum route Fₒₚₜ does not have to be matched to a specific position and orientation of a crop bale 30. Instead, one of the possible arrangements can be selected, which then forms a selection arrangement Cᵢ on which the optimum travel route Fₒₚₜ is based. The selection is based both on the advantageousness of the resulting travel route Fₒₚₜ and on the arrangement probability of the selection arrangement Cᵢ. Qualitatively, the selection arrangement Cᵢ chosen for the route can represent a compromise between arrangement probability and optimization. This principle is illustrated schematically in FIG. 3. The target arrangements S₁-S₃ of three crop bales 30 are shown, each of which is given by arrangement distributions with three position zones PZ₁-PZ₃. For reasons of presentation, orientation is not taken into account here. The optimum route Fₒₚₜ runs through the positions P of three selection arrangements C₁-C₃. In none of the three arrangement distributions the selection arrangement C₁-C₃ is in the first position zone PZ₁, although this corresponds to the highest arrangement probability. On the other hand, the optimum Fₒₚₜ route of the collection unit 20 allows moderate curve radii and a comparatively short travel distance. A first alternative travel route F₁, which could be taken into consideration during planning, enables an almost straight journey and thus an even shorter distance. However, in all three arrangement distributions, this route F₁ only runs through the third position zone PZ₁, which is associated with the lowest arrangement probability.

This route F₁ is therefore not selected. In all three arrangement distributions, a second alternative route F2 runs through the first position zone PZ₁, which is associated with the highest arrangement probability. However, this route F₂ requires tight curve radii, which increases the travel distance and travel time. This route F₂ is therefore not selected either.

In the next step S130 of the process, the collection unit 20 moves to a bale of harvested crop 30. The collection unit 20 is shown in FIG. 2 as a single vehicle, but it could also be a combination resp. trailer, for example. The collection unit 20 can be steered by a driver, but it can also drive autonomously. When a crop bale 30 is approached, the real arrangement R₁-R₆ of the same is determined in a step S140, for example by means of sensors of the collecting unit 20 not shown. In particular, if the real arrangement R₁-R₆ differs from the selection arrangement C₁-C₃, the crop bale 30 is not approached along the target approach path W_{S1}-W_{S6}. However, a deviation from the target approach path W_{S1}-W_{S6} can also be due to other causes, for example a spontaneous decision by the driver, an obstacle that the collection unit 20 has to avoid, or similar. FIG. 4A shows an example of how a different real approach path W_{R2} is used for the second crop bale 30 instead of the target approach path W_{S2}. This can result from the collection unit 20 being controlled manually by a driver, but it can also be determined automatically, and the collection unit 20 can control itself autonomously. In each case, the real approach distance W_{Ri} is recorded in step S150. It is then transmitted to the computer system 50 together with at least one real arrangement Ri. On the one hand, the real arrangement Rᵢ of the crop bale 30 currently being approached can be transmitted, but on the other hand, the real arrangement Rᵢ of at least one other crop bale 30 can also be transmitted if this is already known. In the example of FIG. 4A, the collecting unit 20 can, for example, recognize the real arrangement R3 of the third crop bale 30 while it is still approaching the second crop bale 30.

In a further step S160, the computer system 50 checks whether the real approach path W_{Ri} deviates from the target approach path W_{Si}. Deviations classified as minor on the basis of a defined criterion can be disregarded. Furthermore, a step S170 checks whether one of the transmitted real arrangements Rᵢ deviates from the associated selection arrangement Cᵢ, whereby again minor deviations can be neglected. In step S180, a query is made as to whether there is a deviation that is considered significant. If this is not the case, the next crop bale 30 is selected in step S190 and the process returns to step S130. However, if a deviation is detected, the travel route Fₒₚₜ for the remaining crop bales 30 is recalculated in step S210. On the one hand, the changed initial position of the collection unit 20 due to a deviating real approach path W_{Ri} is taken into account, and on the other hand the deviating real arrangements Rᵢ, insofar as these are known. This means that the newly determined route Fₒₚₜ is based on those crop bales 30 for which real arrangements Rᵢ are already known and not on the selection arrangements Cᵢ. FIG. 4B shows an example of a modified route Fₒₚₜ, which results from the deviations in the real approach path W_{R2} and in the real arrangements R₂, R₃. In particular, the relative position of the second and third crop bales 30 has changed so unfavorably compared to the target arrangements S₂, S₃ that a direct approach to the third crop bale 30 would not be possible or would only be possible with time-consuming maneuvering. For this reason, the third crop bale 30 is initially omitted from the newly determined route Fₒₚₜ and the fourth crop bale 30 is approached instead, as this can be easily reached in accordance with its target arrangement S₄.

In an optional step S200, the target arrangements Sᵢ of the crop bales 30 that have not yet been approached can also be adjusted. As shown in FIG. 8, this step is advantageously carried out before the route Fₒₚₜ is redetermined in step S210. The underlying principle is explained below using FIGS. 5A-5C. FIG. 5A shows the initially given relative arrangement S_{R} in relation to the deposit arrangement A_{P}. As already described, this has three position zones PZ₁, PZ₂ and PZ₃. FIG. 5B shows several positions P, which are assigned to real arrangements R₁-R₅, where again the position P is shown relative to the deposit arrangement A_{P}. Only a small number of the positions P are located in the first position zone PZ₁, while most of the positions P are offset to one side. In addition, all positions P are concentrated in an area that is significantly smaller than the total extent of the three position zones PZ₁-PZ₃. Both indicate an incorrect arrangement distribution. This may be due, for example, to the fact that the properties of the processing area 5 or the properties of the crop bales 30 were incorrectly assessed. There could also be a systematic error in determining the storage arrangement A_{P}. As shown in FIG. 6A, all target arrangements Sᵢ are shifted relative to the real arrangements Rᵢ within the machining area 5. The arrangement distribution can be adjusted accordingly, as shown in FIG. 5C. In the example shown, the three position zones PZ₁-PZ₃ are moved closer to the deposit arrangement A_{P} and the extent of the second and third position zones PZ₂, PZ₃ is reduced. Since the relative arrangement S_{R} is used to determine the target arrangements Sᵢ of all crop bales 30, the target arrangements Sᵢ are shifted forwards in the direction of travel, as shown in FIG. 6B. This achieves a better match with the real arrangements Rᵢ. In a method variant mentioned above, in which the baling press unit 10 does not transmit a deposit arrangement A_{P}, but the target arrangement Sᵢ is estimated on the basis of the deposit interval I_{A}, the deposit interval I_{A} can also be adjusted on the basis of determined real arrangements Rᵢ, which in turn results in changed target arrangements Sᵢ.

FIG. 7A-7C illustrate an orientation of the relative arrangement and its adaptation. FIG. 7A shows three orientation zones OZ₁, OZ₂ and OZ₃, within which the orientations of the arrangement options lie. The arrangement probability is high in a first orientation zone OZ₁, lower in a second orientation zone OZ₂ and lowest in a third orientation zone OZ₃. Alternatively, a continuously varying arrangement probability could also be assumed here. FIG. 7B shows several orientations O, which are assigned to real arrangements R₁-R₅. These are not evenly distributed around the orientation O of the storage arrangement A_{P}, but are shifted to one side. In addition, the orientations P are arranged in an area that is smaller than the total extent of the three orientation zones OZ₁-OZ₃. Accordingly, as shown in FIG. 7C, the arrangement distribution can be adjusted by shifting the three orientation zones OZ₁-OZ₃ to one side and reducing their extent.

FIG. 9A to 9C show examples of how the arrangement distribution can also be adapted independently of already known real arrangements by including parameters that affect the processing area 5. FIG. 9A shows an arrangement distribution in a flat section of the machining area 5, i.e. a section without a significant gradient G. This corresponds to the distribution shown in FIG. 8A. FIG. 9B shows an arrangement distribution in a section in which a gradient G is given that runs at a 90° angle to the orientation O of the deposit arrangement A_{P}. The arrangement distribution shifts in the direction of the gradient G, and the shape of the position zones PZ₁-PZ₃ is distorted. This reflects the assumption that the crop bales 30 tend to move in the direction of the slope G during placement. FIG. 9C shows an arrangement distribution in a section in which the gradient G runs in the opposite direction to the orientation of the deposit arrangement A_{P}. The arrangement distribution shifts in the direction of the slope G away from the deposit arrangement A_{P}, and the shape of the position zones PZ₁-PZ₃ is elongated.

1. A method for planning the pick-up of crop bales (30) arranged in a processing area (5) by a collecting unit (20), with the steps of:
Providing (S110) arrangement information corresponding to an expected target arrangement (Si) of each of a plurality of crop bales (30), and
Computer-aided determination (S120) of an optimum route (Fₒₚₜ) for picking up the plurality of crop bales (30) on the basis of the arrangement information, in accordance with a defined optimization criterion for route optimization, the optimum route (Fₒₚₜ) containing a target approach path (W_{S1}-W_{S6}) for each crop bale (30), along which the crop bale (30) is to be approached,
characterized in that
arrangement information is provided (S110), in which the desired arrangement (Sᵢ) of at least one crop bale (30) corresponds to an arrangement distribution with a plurality of arrangement possibilities, wherein an arrangement probability is assigned to each arrangement possibility, and wherein a selection arrangement (Cᵢ) is selected from the plurality of arrangement possibilities when determining (S120) the optimum travel route (Fₒₚₜ) for at least one crop bale (30).

2. The method according to claim 1, characterized in that the selection arrangement (Cᵢ) is selected both as a function of its arrangement probability and of the optimization criterion.

3. The method according to claim 1, characterized in that the target arrangement (Sᵢ) of a crop bale (30) corresponds to at least one translational position (P) and at least one rotational orientation (O) thereof.

4. The method according to claim 1, characterized in that the crop bales (30) are approached (S130) by the collecting unit (20), a real arrangement (Ri) of the respective crop bale (30) being determined (S140) as it is approached, and the crop bale (30) being approached along a real approach path (W_{Ri}) in accordance with the real arrangement (Rᵢ).

5. The method according to claim 1, characterized in that the real arrangement (Rᵢ) and preferably the real approach path (W_{Ri}) are determined automatically.

6. The method according to claim 1, characterized in that if the real approach path (W_{Ri}) of a crop bale deviates from the target approach path (W_{S1}-W_{S6}), the optimum travel route (Fₒₚₜ) is at least partially determined again (S210) with the aid of a computer, taking into account the deviating real approach path (W_{Ri}).

7. The method according to claim 1, characterized in that if the real arrangement (Rᵢ) of a crop bale (30) deviates from its selection arrangement (Cᵢ), the optimum travel route (Fₒₚₜ) is again determined (S210) at least partially with the aid of a computer, taking into account the deviating real arrangement (Rᵢ).

8. The method according to claim 1, characterized in that the collecting unit (20) approaches and picks up the crop bales (30) autonomously.

9. The method according to claim 1, characterized in that the arrangement information is determined at least partly based on operating data (D_{B}) of a baling unit (10) which has deposited the crop bales (30) in the processing area (5), and/or on area data (D_{A}) which describe a condition of the processing area (5).

10. The method according to claim 1, characterized in that the operating data (DB) describe at least one baler travel route (F_{P}) of the baling press unit (10).

11. The method according to claim 1, characterized in that the operating data (D_{B}) describe positions (P) and/or orientations (O) of crop bales (30).

12. The method according to claim 1, characterized in that, to determine the arrangement information, positions (P) of crop bales (30) are estimated on the basis of the baler travel route (F_{P}) and of a deposit interval (I_{A}) which corresponds to a travel distance of the baler unit (10) between two bale deposits.

13. The method according to claim 1, characterized in that for determining the arrangement information, orientations (O) of crop bales (30) are estimated on the basis of the baler travel route (F_{P}).

14. The method according to claim 1, characterized in that, in order to determine the target arrangement (Sᵢ) of a plurality of crop bales (30), a depositing arrangement (A_{P}) is taken as a basis which corresponds to a position (P) and/or orientation (O) of the baling unit (10) or of the respective crop bale (30) when the crop bale (30) is deposited, and this is combined with a relative arrangement (A_{R}) of the crop bale (30) relative to the depositing arrangement (A_{P}).

15. The method according to claim 1, characterized in that the desired arrangement (Sᵢ) of at least one crop bale (30) still to be approached is updated (S200) based on the real arrangement (Rᵢ) of at least one crop bale (30) already approached, the relative arrangement (A_{P}) preferably being updated.

16. A computer system (50) for planning the pick-up of crop bales (30) arranged in a processing area (5) by a collecting unit (20), wherein the computer system (50) is arranged:
to detect arrangement information corresponding to an expected target arrangement (Sᵢ) of each of a plurality of crop bales (30), and
to determine (S110) by aid of computer an optimum route (Fₒₚₜ) for picking up the plurality of crop bales (30) on the basis of the arrangement information, in accordance with a defined optimization criterion for route optimization, the optimum route (Fₒₚₜ) containing a target approach path (W_{Si}) for each crop bale (30), along which the crop bale (30) is to be approached,
characterized in that
the computer system (50) is set up to acquire arrangement information in which the desired arrangement (Sᵢ) of at least one crop bale (30) corresponds to an arrangement distribution with a plurality of arrangement possibilities, wherein an arrangement probability is assigned to each arrangement possibility, and wherein a selection arrangement (Cᵢ) is selected from the plurality of arrangement possibilities when determining (S120) the optimum travel route (Fₒₚₜ) for at least one crop bale (30).
